(19) United States
(12) Patent Application Publication
(10) Pub. No.: US 2009/0168211 A1
(43) Pub. Date: Jul. 2, 2009

(54) Auxiliary mirror assembly for sideview mirror of car

(76) Inventor: Fu-Chu Su, Yongkang City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/964,190

(22) Filed: Dec. 26, 2007

(51) Int. Cl. G02B 7/182

(52) U.S. Cl. 359/879; 359/871

(57) ABSTRACT

An auxiliary mirror assembly for a sideview mirror of a car includes an auxiliary mirror including a mirror body and a connecting base, a first support bar and a second support bar each mounted on the connecting base, a first holding base and a second holding base each mounted on the first support bar and each provided with at least one holding flange, a locking hook and a binding strap. Thus, the first support bar and the second support bar are combined with the sideview mirror to attach the auxiliary mirror to the sideview mirror to extend the side-viewing distance of the sideview mirror so that when a trailer is attached to the car, the driver in the car can see clearly the trailer behind the car by the auxiliary mirror.

### BACKGROUND OF THE INVENTION

1. Field of the Invention

The present invention relates to an auxiliary mirror assembly and, more particularly, to an auxiliary mirror assembly for a sideview mirror of a car.

2. Description of the Related Art

A conventional sideview mirror of a car is mounted on a side of a car to provide a side-viewing effect to a driver in the car to protect the driver's safety. However, the angle of the sideview mirror is usually designed to fit the size of the car, so that when a trailer is attached to the car, the driver in the car cannot see clearly the trailer behind the car, thereby easily causing danger to the driver.

### BRIEF SUMMARY OF THE INVENTION

In accordance with the present invention, there is provided an auxiliary mirror assembly for a sideview mirror of a car, comprising an auxiliary mirror including a mirror body and a connecting base, a first support bar having a first end mounted on the connecting base of the auxiliary mirror, a first holding base mounted on a second end of the first support bar and having a first side provided with at least one first holding flange and a second side provided with a first locking hook and a first binding strap, a second support bar having a first end mounted on the connecting base of the auxiliary mirror, and a second holding base mounted on a second end of the second support bar and having a first side provided with at least one second holding flange and a second side provided with a second locking hook and a second binding strap.

The primary objective of the present invention is to provide an auxiliary mirror assembly for a sideview mirror of a car, wherein the first support bar and the second support bar are combined with the sideview mirror to attach the auxiliary mirror to the sideview mirror so as to extend the side-viewing distance of the sideview mirror by aid of the auxiliary mirror so that when a trailer is attached to the car, the driver in the car can see clearly the trailer behind the car by the auxiliary mirror.

Another objective of the present invention is to provide an auxiliary mirror assembly for a sideview mirror of a car, wherein the first support bar and the second support bar are combined with the sideview mirror exactly and closely, so that the auxiliary mirror is attached to the sideview mirror solidly and stably so as to prevent the auxiliary mirror from being loosened from the sideview mirror.

A further objective of the present invention is to provide an auxiliary mirror assembly for a sideview mirror of a car, wherein the connecting base of the auxiliary mirror is pivotally mounted on the mirror body by the universal connector, so that the mirror body can be pivoted relative to the connecting base to adjust the angle of the mirror body according to the user's practical requirement.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of an auxiliary mirror assembly in accordance with the preferred embodiment of the present invention.

FIG. 2 is an exploded perspective view of the auxiliary mirror assembly as shown in FIG. 1.

FIG. 3 is a perspective view showing the auxiliary mirror assembly for a sideview mirror of a car.

FIG. 4 is a locally front view of the auxiliary mirror assembly for a sideview mirror of a car as shown in FIG. 3.

FIG. 5 is a side cross-sectional view of the auxiliary mirror assembly for a sideview mirror of a car as shown in FIG. 3.

### DETAILED DESCRIPTION OF THE INVENTION

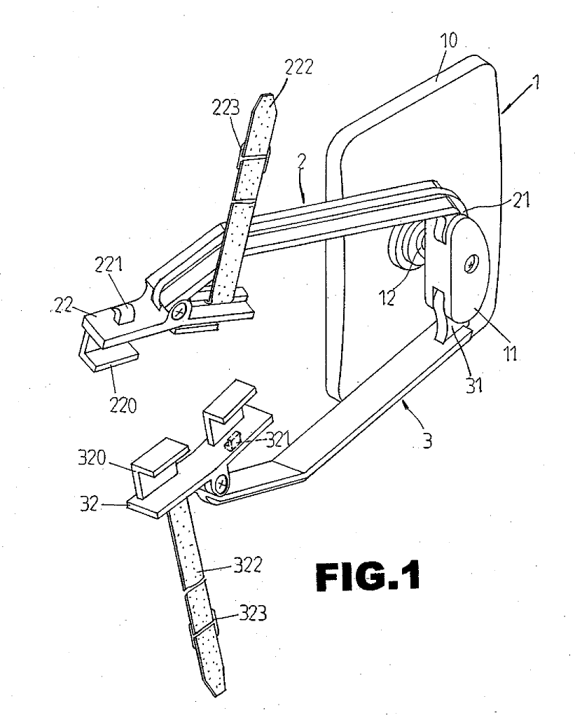

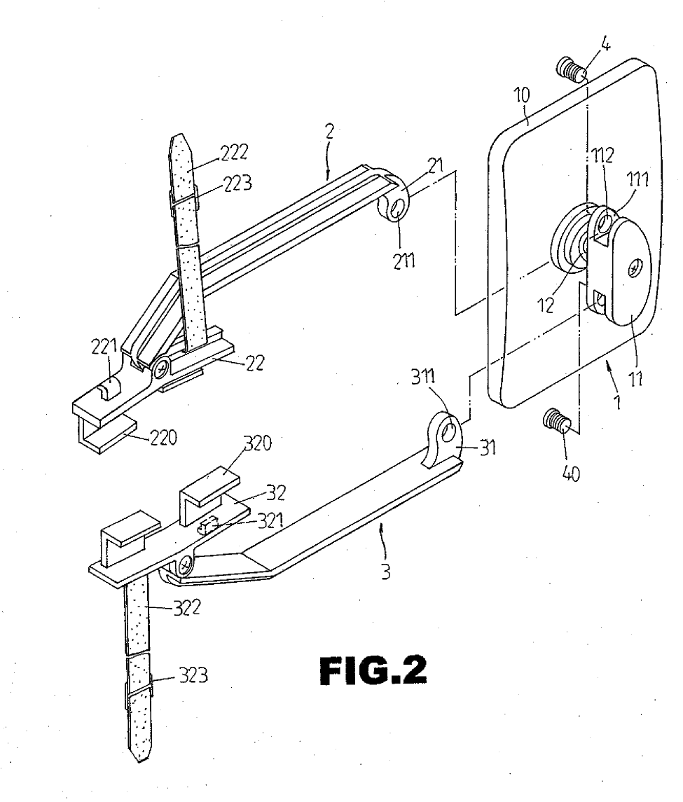

Referring to the drawings and initially to FIGS. 1 and 2, an auxiliary mirror assembly for a sideview mirror of a car in accordance with the preferred embodiment of the present invention comprises an auxiliary mirror 1 including a mirror body 10 and a connecting base 11, a first support bar 2 having a first end mounted on the connecting base 11 of the auxiliary mirror 1, a first holding base 22 mounted on a second end of the first support bar 2 and having a first side provided with at least one first holding flange 220 and a second side provided with a first locking hook 221 and a first binding strap 222, a second support bar 3 having a first end mounted on the connecting base 11 of the auxiliary mirror 1, and a second holding base 32 mounted on a second end of the second support bar 3 and having a first side provided with at least one second holding flange 320 and a second side provided with a second locking hook 321 and a second binding strap 322.

The connecting base 11 of the auxiliary mirror 1 is pivotally mounted on the mirror body 10 by a universal connector 12. The connecting base 11 of the auxiliary mirror 1 has two opposite ends each provided with a pivot groove 111. The pivot groove 111 of the connecting base 11 has two opposite sides each provided with a screw bore 112.

The first support bar 2 has a bent shape. The first end of the first support bar 2 is provided with a protruding pivot ear 21 pivotally mounted in the respective pivot groove 111 of the connecting base 11. The pivot ear 21 of the first support bar 2 is provided with a pivot hole 211.

The auxiliary mirror assembly further comprises a first fastening screw 4 extending through the pivot hole 211 of the first support bar 2 and screwed into the respective screw bore 112 of the connecting base 11 to connect the first support bar 2 with the connecting base 11 of the auxiliary mirror 1.

The second support bar 3 has a bent shape. The first end of the second support bar 3 is provided with a protruding pivot ear 31 pivotally mounted in the respective pivot groove 111 of the connecting base 11. The pivot ear 31 of the second support bar 3 is provided with a pivot hole 211.

The auxiliary mirror assembly further comprises a second fastening screw 40 extending through the pivot hole 311 of the second support bar 3 and screwed into the respective screw bore 112 of the connecting base 11 to connect the second support bar 3 with the connecting base 11 of the auxiliary mirror 1.

The first holding base 22 is pivotally mounted on the second end of the first support bar 2. Preferably, the first holding base 22 is provided with two opposite first holding flanges 220. The first holding flange 220 of the first holding base 22 has a substantially L-shaped profile. The first binding strap 222 of the first holding base 22 is provided with a first snapping member 223.

The second holding base 32 is pivotally mounted on the second end of the second support bar 3. Preferably, the second holding base 32 is provided with two opposite second holding flanges 320. The second holding flange 320 of the second holding base 32 has a substantially L-shaped profile. The second binding strap 322 of the second holding base 32 is provided with a second snapping member 323.

In the preferred embodiment of the present invention, the first locking hook 221 of the first holding base 22 and the second binding strap 322 of the second holding base 32 align with each other, so that the second snapping member 323 of the second binding strap 322 is snapped onto the first locking hook 221 of the first holding base 22, while the second locking hook 321 of the second holding base 32 and the first binding strap 222 of the first holding base 22 align with each other, so that the first snapping member 223 of the first binding strap 222 is snapped onto the second locking hook 321 of the second holding base 32.

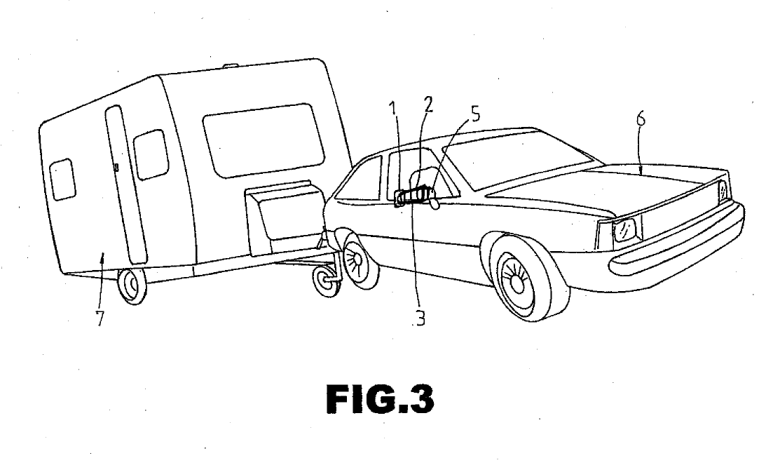

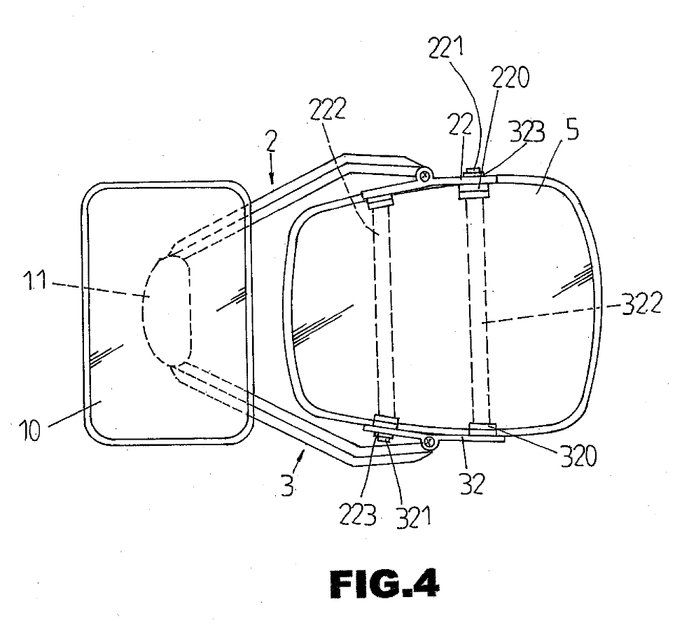

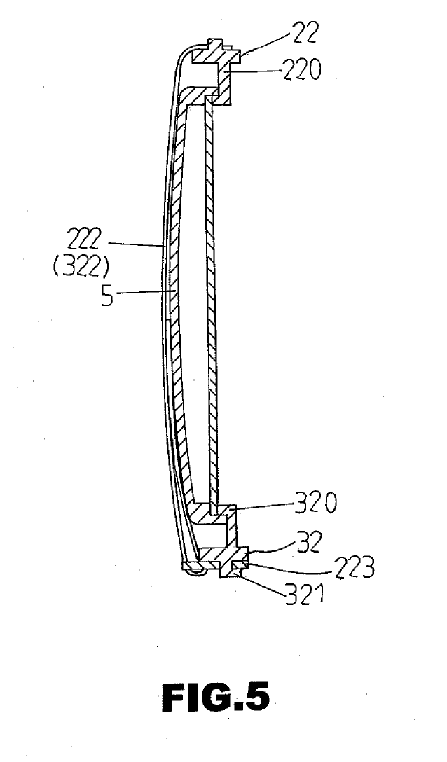

In operation, referring to FIGS. 3-5 with reference to FIGS. 1 and 2, the first holding flange 220 of the first holding base 22 and the second holding flange 320 of the second holding base 32 are movable to abut an inner rim of a sideview mirror 5 of a car 6. Then, the first binding strap 222 of the first holding base 22 is enclosed around a rear side of the sideview mirror 5, and the first snapping member 223 of the first binding strap 222 is snapped onto the second locking hook 321 of the second holding base 32. Similarly, the second binding strap 322 of the second holding base 32 is enclosed around the rear side of the sideview mirror 5, and the second snapping member 323 of the second binding strap 322 is snapped onto the first locking hook 221 of the first holding base 22. In such a manner, the first support bar 2 and the second support bar 3 are combined with the sideview mirror 5 to attach the auxiliary mirror 1 to the sideview mirror 5 to extend the side-viewing distance of the sideview mirror 5 so that when a trailer 7 is attached to the car 6, the driver in the car 6 can see clearly the trailer 7 behind the car 6.

Accordingly, the first support bar 2 and the second support bar 3 are combined with the sideview mirror 5 to attach the auxiliary mirror 1 to the sideview mirror 5 so as to extend the side-viewing distance of the sideview mirror 5 by aid of the auxiliary mirror 1 so that when a trailer 7 is attached to the car 6, the driver in the car 6 can see clearly the trailer 7 behind the car 6 by the auxiliary mirror 1. In addition, the first support bar 2 and the second support bar 3 are combined with the sideview mirror 5 exactly and closely, so that the auxiliary mirror 1 is attached to the sideview mirror 5 solidly and stably so as to prevent the auxiliary mirror 1 from being loosened from the sideview mirror 5. Further, the connecting base 11 of the auxiliary mirror 1 is pivotally mounted on the mirror body 10 by the universal connector 12, so that the mirror body 10 can be pivoted relative to the connecting base 11 to adjust the angle of the mirror body 10 according to the user's practical requirement.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An auxiliary mirror assembly for a sideview mirror of a car, comprising:
an auxiliary mirror including a mirror body and a connecting base;
a first support bar having a first end mounted on the connecting base of the auxiliary mirror;
a first holding base mounted on a second end of the first support bar and having a first side provided with at least one first holding flange and a second side provided with a first locking hook and a first binding strap;
a second support bar having a first end mounted on the connecting base of the auxiliary mirror;
a second holding base mounted on a second end of the second support bar and having a first side provided with at least one second holding flange and a second side provided with a second locking hook and a second binding strap.

2. The auxiliary mirror assembly for a sideview mirror of a car in accordance with claim 1, wherein
the connecting base of the auxiliary mirror has two opposite ends each provided with a pivot groove;
the first end of the first support bar is provided with a protruding pivot ear pivotally mounted in the respective pivot groove of the connecting base;
the first end of the second support bar is provided with a protruding pivot ear pivotally mounted in the respective pivot groove of the connecting base.

3. The auxiliary mirror assembly for a sideview mirror of a car in accordance with claim 2, wherein
the pivot groove of the connecting base has two opposite sides each provided with a screw bore;
the pivot ear of the first support bar is provided with a pivot hole;
the auxiliary mirror assembly further comprises a first fastening screw extending through the pivot hole of the first support bar and screwed into the respective screw bore of the connecting base to connect the first support bar with the connecting base of the auxiliary mirror;
the pivot ear of the second support bar is provided with a pivot hole;
the auxiliary mirror assembly further comprises a second fastening screw extending through the pivot hole of the second support bar and screwed into the respective screw bore of the connecting base to connect the second support bar with the connecting base of the auxiliary mirror.

4. The auxiliary mirror assembly for a sideview mirror of a car in accordance with claim 1, wherein the connecting base of the auxiliary mirror is pivotally mounted on the mirror body by a universal connector.

5. The auxiliary mirror assembly for a sideview mirror of a car in accordance with claim 1, wherein
the first holding base is pivotally mounted on the second end of the first support bar;
the second holding base is pivotally mounted on the second end of the second support bar.

6. The auxiliary mirror assembly for a sideview mirror of a car in accordance with claim 1, wherein
the first holding base is provided with two opposite first holding flanges;
the second holding base is provided with two opposite second holding flanges.

7. The auxiliary mirror assembly for a sideview mirror of a car in accordance with claim 1, wherein
the first holding flange of the first holding base has a substantially L-shaped profile;
the second holding flange of the second holding base has a substantially L-shaped profile.

8. The auxiliary mirror assembly for a sideview mirror of a car in accordance with claim 1, wherein
the first binding strap of the first holding base is provided with a first snapping member;
the second binding strap of the second holding base is provided with a second snapping member.

9. The auxiliary mirror assembly for a sideview mirror of a car in accordance with claim 8, wherein
the first locking hook of the first holding base and the second binding strap of the second holding base align with each other;
the second snapping member of the second binding strap is snapped onto the first locking hook of the first holding base;
the second locking hook of the second holding base and the first binding strap of the first holding base align with each other;
the first snapping member of the first binding strap is snapped onto the second locking hook of the second holding base.

10. The auxiliary mirror assembly for a sideview mirror of a car in accordance with claim 9, wherein
the first holding flange of the first holding base and the second holding flange of the second holding base are movable to abut an inner rim of a sideview mirror;
the first binding strap of the first holding base is enclosed around the rear side of the sideview mirror, and the first snapping member of the first binding strap is snapped onto the second locking hook of the second holding base;
the second binding strap of the second holding base is enclosed around a rear side of the sideview mirror, and the second snapping member of the second binding strap is snapped onto the first locking hook of the first holding base.

11. The auxiliary mirror assembly for a sideview mirror of a car in accordance with claim 1, wherein the first support bar has a bent shape.

12. The auxiliary mirror assembly for a sideview mirror of a car in accordance with claim 1, wherein the second support bar has a bent shape.
